(19) United States
(12) Patent Application Publication
(10) Pub. No.: US 2026/0310240 A1
(43) Pub. Date: Oct. 8, 2026

(54) FLAT FOLDING MULTI-AXIS POSITIONING SYSTEMS AND METHODS

(71) Applicant: Andre Coville, Rome, GA (US)

(72) Inventor: Andre Coville, Rome, GA (US)

(21) Appl. No.: 19/633,253

(22) Filed: Mar. 30, 2026

Related U.S. Application Data
(60) Provisional application No. 63/782,228, filed on Apr. 2, 2025.

(51) Int. Cl. G05D 3/10; B25J 9/10

(52) U.S. Cl. CPC G05D 3/105; B25J 9/106

(57) ABSTRACT

A multi-axis positioning system includes a base structure defining a perimeter, a motion platform defining a perimeter, and a plurality of motion devices each having a first end connected to the perimeter of the base structure and a second end connected to the perimeter of the motion platform. The motion devices are configured to collectively position the motion platform at multiple orientations relative to the base structure, including orientations with angular displacement about at least two different axes. When fully retracted, the motion platform is positioned immediately adjacent to the base structure to provide an extremely low-profile stowed position. The interior volume between the base structure and motion platform remains substantially unobstructed by the motion devices throughout the range of motion. Applications include solar panel positioning, optical alignment, antenna pointing, manufacturing and industrial positioning systems, and structural systems for mobile applications.

### CROSS-REFERENCE TO RELATED APPLICATIONS

This application claims the benefit of and priority to U.S. Provisional Patent Application Ser. No. 63/782,228, filed Apr. 2, 2025, entitled “MOBILE SOLAR ENERGY SYSTEMS AND METHODS,” the entire disclosure of which is hereby incorporated by reference in its entirety for all purposes.

### FIELD

The present invention relates generally to multi-axis positioning systems. More particularly, the present invention relates to systems and methods for positioning panels and other objects, such as solar panels, antennas, optical devices, and other items that require controlled orientation, with multiple degrees of freedom relative to a base surface using perimeter-mounted linear motion and other orienting devices.

### BACKGROUND

There is a long-felt need in various industries for positioning systems that can orient objects through multiple degrees of freedom while maintaining structural stability. Conventional solutions to this problem include Stewart-Gough platforms, which employ six actuators connected between a base platform and a motion platform in a triangular or hexagonal configuration. These six-actuator designs are widely used in flight simulators, industrial machinery, and other applications requiring multi-axis motion.

However, conventional Stewart-Gough platforms and similar prior art systems suffer from significant limitations. First, the actuators are typically positioned within the interior volume between the base and motion platforms, which obstructs the usable space and makes these systems unsuitable for applications where a clear interior volume is required or preferred, such as aiming optics, focusing light collectors, or integrating into vehicle roof structures. Second, these systems generally cannot fold into a flat, low-profile position. The geometric arrangement of the actuators prevents the motion platform from collapsing closely adjacent to the base structure, making them unsuitable for transportation, size-constrained applications, or any use case requiring compact stowage. Third, conventional platforms are not designed as thin, modular layers that can be easily integrated into existing structures. Instead, they require dedicated mounting systems and significant structural modifications. Finally, Stewart-Gough platforms require triangular or hexagonal platforms/bases. In order to control a rectangular motion platform, or to interface with a rectangular base, one must build a separate triangle or hexagon into the interior of both rectangles. This is a significant obstacle to cleanly integrating a conventional motion platform into a natively rectangular system like a solar array or a vehicle chassis.

Now, recreational vehicles (RVs) are trailers or vehicles that provide storage space and living space and that are either towed behind another vehicle or are self propelling. Many RVs are designed with low roofs to, among other things, improve their aerodynamics. In some cases, roofs of RVs are designed to be lowered while the RV is driven and then raised to provide additional headroom when the RV is not being driven. Referring to FIG. 1 and FIG. 2, a conventional vehicle 100 in the form of an RV having a roof 102 is shown.

FIG. 1 shows the vehicle 100 with the roof 102 in a fully lowered position suitable for travel. In this lowered position, the roof 102 sits close to the main body of the vehicle, providing a low-profile configuration that reduces aerodynamic drag during transit. FIG. 2 shows the same vehicle 100 with the roof 102 in a vertically raised position. When parked and not in motion, the roof 102 can be elevated vertically to provide additional headroom and living space within the vehicle. However, conventional pop-up roofs, such as roof 102, provide only a single degree of freedom: vertical translation. The roof 102 moves up and down but cannot tilt or rotate about horizontal axes. This limitation prevents the roof 102 from being oriented at angles relative to the vehicle 100, which would be advantageous for applications such as solar tracking, antenna positioning, or other directional requirements. Additionally, conventional pop-up mechanisms typically employ actuators or lift mechanisms positioned at discrete points, often at corners, which may not provide optimal load distribution or structural stability for applications involving significant external forces such as wind loading.

In setting up and using a solar panel system comprised of an array of solar panels, to maximize the effectiveness and efficiency of the system, a primary consideration is orienting the solar panels towards the sun. In general, solar panels work best when the panels themselves are oriented such that they face directly towards the sun to allow the photovoltaic (PV) cells of the solar panels to absorb the rays of the sun. Even a slight angle between the solar panel and the sun may cause the PV cells to reflect the sun's rays rather than absorb them. Thus, correct alignment of solar panels can make a drastic difference in their output. For example, in some cases, arrays that are correctly oriented can improve energy output by 40% or more. Therefore, improving the alignment can not only improve energy output but can also reduce the number of solar panels and the amount of time needed to produce a given amount of energy.

Fixed solar arrays, such as those located at a house or business, can be and often are much larger than mobile solar arrays, such as those mounted to a vehicle, trailer, mobile battery, or other vehicle. With a ground-mounted or fixed array, more power can be added simply by adding additional panels. Thus, more power can be added without relying on a complex sun tracking system. On the other hand, on a vehicle, once the maximum number of panels has been placed onto the vehicle, the only way to increase the amount of power is through solar tracking.

For this reason (i.e., because arrays on vehicles are smaller), solar tracking in a vehicle-borne solar array is much more important than solar tracking for a ground-mount array. However, existing vehicle-borne sun tracking systems for solar arrays are rare. Most existing mobile solar systems employ a solar array that is deployed at a fixed tilt angle and that relies on the vehicle operator to manually orient the vehicle in the most effective and efficient direction. To address this concern, some RVs have dedicated sun tracking capabilities that add complete, single function assemblies that are heavy, bulky and are sold as stand-alone accessories.

In the past, designers have focused primarily on stand-alone sun tracking systems that are not well integrated into vehicles' native systems. However, unfortunately, these systems add weight and complexity to the vehicle and are not an elegant use of the existing potential functionality in the existing mechanical systems in the vehicle, especially a RV or trailer. For example, FIG. 3 shows a conventional three-actuator motion platform system 104 representative of prior art platform designs that may be used for this purpose. The system 104 includes a base structure 106, a motion platform 108, and three linear actuators 110 positioned between the base and motion platform. The actuators 110 are arranged in a triangular pattern, with each actuator extending inward from the perimeter toward the center of the platform 108. This interior-mounted actuator arrangement is characteristic of 3-Dof motion platforms and can provide three degrees of freedom through coordinated extension and retraction of the three actuators.

Unfortunately, in addition to its weight, this type of system 104 also adds complexity and is associated with other issues as well. For example, when in use, the actuators 110 remain positioned within and fill the interior volume of the motion platform 108 even as the motion platform tilts. The geometric constraints of the triangular actuator arrangement limit the platform's 108 ability to achieve a flat-folded position. When the actuators 110 are fully retracted, the motion platform 108 cannot collapse closely adjacent to the base structure 106 because the actuator mounting points and the angular geometry prevent close proximity between the platforms. Additionally, the interior-mounted actuators obstruct the space between the base structure 106 and motion platform 108 throughout the entire range of motion, making this design unsuitable for applications requiring a clear interior volume such as aiming optics, focusing light collectors, or integrating into vehicle roof structures.

The limitations of the prior art described above have prevented the development of effective multi-axis positioning systems for mobile applications such as vehicle-mounted solar arrays, compact satellite optics, and other size-constrained or transportation-sensitive applications. What is needed, therefore, is a multi-axis positioning system that can fold flat into a low-profile package, preserve usable interior volume throughout its range of motion, provide substantial vertical lift and angular range, and integrate easily as a modular layer into existing structures, all while maintaining structural stability and the ability to resist external forces such as wind loading.

### SUMMARY OF THE INVENTION

In accordance with various embodiments of the present disclosure, a multi-axis positioning system is provided. The system comprises a base structure defining a perimeter, a motion platform defining a perimeter, and a plurality of motion devices. Each motion device has a first end and a second end, with the first end connected to the perimeter of the base structure and the second end connected to the perimeter of the motion platform. The plurality of motion devices are configured to collectively position the motion platform at a plurality of orientations relative to the base structure, including orientations with angular displacement about at least two different axes. While solar tracking applications utilize three degrees of freedom (vertical translation, pitch, and roll), the system architecture provides full six-degree-of-freedom capability including pitch, yaw, roll, and translation in X, Y, and Z directions.

In certain embodiments, the base structure and motion platform each have a polygonal shape, such as rectangular, square, or hexagonal. In other embodiments, the base structure and/or motion platform may have a circular or oval shape. The plurality of motion devices may be arranged such that at least two motion devices are positioned along each side or perimeter section of the base structure and motion platform.

In some embodiments, when the motion devices are extended, at least some of the motion devices cross one another to form an “X” pattern when viewed from the side, thereby providing enhanced mechanical advantage and increased vertical lift, and increased range of motion in pitch, yaw and roll. In alternative embodiments, the motion devices may be arranged in a non-crossing position.

The motion devices may comprise electric linear actuators, hydraulic cylinders, pneumatic cylinders, telescoping struts, screw-driven actuators, or other devices capable of providing controlled linear extension and retraction. Each motion device may be connected to the base structure and motion platform via universal joints, ball joints, spherical bearings, or other connection mechanisms that permit angular displacement.

In certain embodiments, the system further comprises a control system configured to control extension and retraction of each of the plurality of motion devices. The control system may employ inverse kinematics calculations to determine required extension lengths for each motion device to achieve a desired position and orientation of the motion platform. The control system may further comprise sensors for detecting the position and orientation of the motion platform, and may include programming for automated sun tracking when the system is used for solar panel positioning.

When in a fully retracted position, the motion platform may be positioned immediately adjacent to the base structure such that the overall height of the system is substantially equal to the combined thickness of the base structure and the motion platform, thereby providing an extremely low-profile stowed position. The interior volume between the base structure and motion platform remains substantially unobstructed by the motion devices, allowing the space to be used for other purposes or allowing light or other signals to pass through.

In certain embodiments configured for solar panel applications, one or more solar panels are mounted to the motion platform. The control system may be programmed to periodically adjust the orientation of the motion platform to track the position of the sun, thereby maximizing energy collection. In such embodiments, the system may be mounted on a mobile vehicle unit such as a recreational vehicle, trailer, van, or other vehicle.

Methods of positioning a panel relative to a base surface are also provided. Such methods may comprise providing a positioning system as described above, mounting a panel to the motion platform, determining a desired orientation for the panel, and controlling the plurality of motion devices to position the motion platform, and thereby the panel, at the desired orientation.

These and other features and advantages of the multi-axis positioning systems and methods will become apparent from the following detailed description of preferred embodiments, taken in conjunction with the accompanying drawings.

### NOTES ON CONSTRUCTION

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

### BRIEF DESCRIPTION OF DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 is a side elevation view of a conventional vehicle having a roof in a fully lowered position;

FIG. 2 is a perspective view of the vehicle of FIG. 1 showing the roof, with a single degree of freedom, moved vertically to a fully raised position;

FIG. 3 shows a conventional three-actuator, 3 degree of freedom motion platform;

FIG. 4 is a rear left perspective view of a mobile vehicle unit (MVU) according to an embodiment of the present invention, showing a multi-axis positioning system (MAPS) with a tiltable roof and solar array in a fully lowered position;

FIG. 5 is a front left perspective view of the MVU of FIG. 4, showing the tiltable roof raised to a fully extended (elevated and horizontal) position;

FIG. 6 is a side elevation view of the MVU of FIG. 4, showing the tiltable roof tilted to a rearward tilting position;

FIG. 7 is a front left perspective view of the MVU of FIG. 4, showing the tiltable roof laterally tilted;

FIG. 8A is a rear left perspective view of the MVU of FIG. 6, showing the tiltable roof tilted to a forward tilting position and where the MVU is also tilted with respect to wheels;

FIG. 8B is a rear left perspective view of the MVU of FIG. 7, showing the tiltable roof laterally tilted and where the MVU is also tilted with respect to wheels;

FIG. 8C is a rear left perspective view of the MVU of FIG. 8A, showing the tiltable roof laterally and forwardly tilted such that a front-left corner of the solar array is tilted downward and where the MVU is also tilted with respect to wheels;

FIG. 9A is a front left perspective view of the MVU of FIG. 8A;

FIG. 9B is a front left perspective view of the MVU of FIG. 8B;

FIG. 9C is a front left perspective view of the MVU of FIG. 8C;

FIGS. 10 and 11 are diagrams depicting a MAPS in accordance with an embodiment of the present invention used in connection with the MVU of FIGS. 8A-8C and 9A-9C, showing movement devices mounted between the MVU and the roof for repositioning the roof and also including a suspension or jacking system for repositioning the MVU itself;

FIG. 12 is a top plan view of a MAPS according to a second embodiment of the present invention, showing a rectangular frame with crossing motion devices;

FIG. 13 is a side elevation view of the MAPS of FIG. 12;

FIG. 14 is a perspective view of the MAPS of FIG. 12, showing the motion platform in a collapsed position;

FIG. 15 is a perspective view of the MAPS of FIG. 12, showing the motion platform in an intermediate, partially raised position with a top surface of a motion platform oriented at an angle relative to a ground surface;

FIG. 16 is a perspective view of the MAPS of FIG. 12, showing the motion platform in a fully raised horizontal position;

FIGS. 17-19 are three different perspective views of the MAPS of FIG. 12, showing the motion platform partially raised and tilted on two orthogonal axes;

FIG. 20 is a top plan view of a third embodiment of a MAPS according to the present invention, showing a rectangular frame with non-crossing butt-to-butt motion devices;

FIG. 21 is a sectional view of the MAPS of FIG. 20, taken along line 21-21; and

FIG. 22 is a perspective view of the MAPS of FIG. 20, showing the motion platform in a partially raised two-axis tilt position.

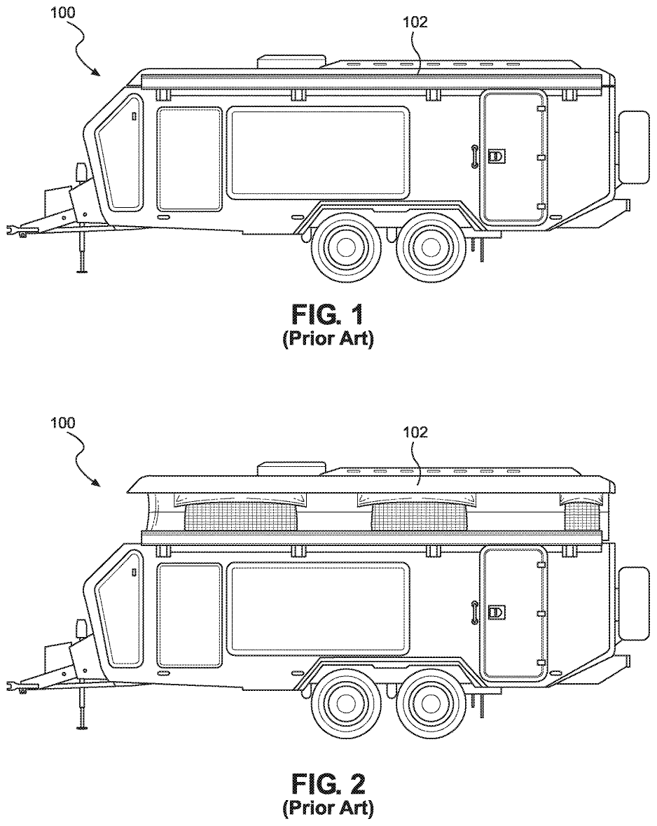

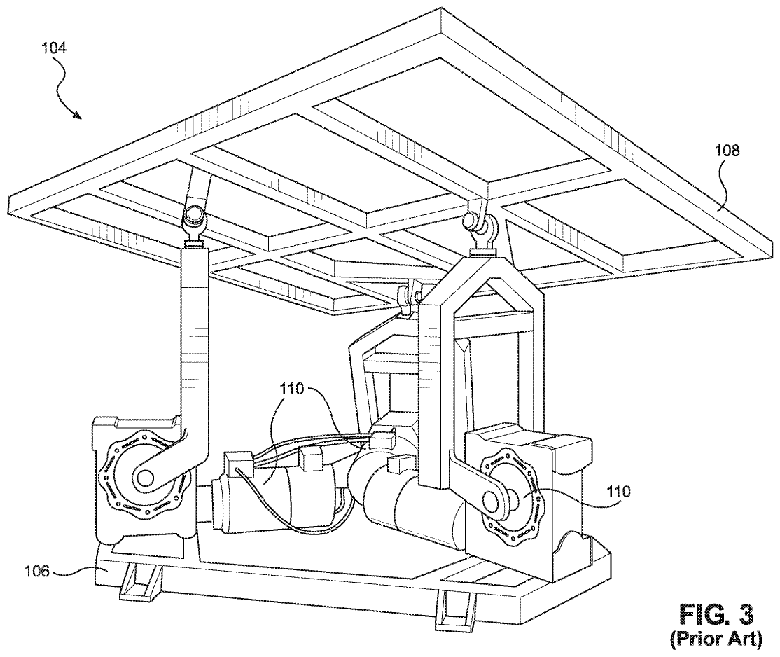

### DETAILED DESCRIPTION OF THE INVENTION

The present invention provides multi-axis positioning systems (MAPS) and methods that overcome the limitations of conventional motion platforms. By positioning motion devices primarily around the perimeter of a base structure and motion platform, rather than within the interior volume, the disclosed systems achieve a unique combination of features: the ability to fold flat into an extremely low-profile position, preservation of usable interior volume throughout the entire range of motion, substantial vertical lift and angular range despite compact motion device dimensions, and excellent structural stability for resisting external forces such as wind loading.

The perimeter-mounted architecture enables these systems to be integrated as thin, modular layers onto existing structures without requiring dedicated mounting systems or significant structural modifications. This makes embodiments of the present invention particularly well-suited for mobile applications such as vehicle-mounted solar arrays, compact satellite optics, and other size-constrained or transportation-sensitive applications where conventional actuator platforms cannot be used effectively.

The following detailed description presents several embodiments and applications of the invention. These embodiments illustrate the versatility and broad applicability of the perimeter-mounted MAPS architecture, but should not be construed as limiting the scope of the invention to these specific positions. While solar tracking applications typically require only three degrees of freedom (i.e., vertical translation, pitch rotation, and roll rotation) the perimeter-mounted MAPS architecture described herein is capable of providing all six degrees of freedom (i.e., pitch, yaw, roll, and translation in X, Y, and Z). This full six-DOF capability makes the system suitable for a broad range of applications beyond solar tracking, including optical aiming systems, antenna positioning, manufacturing workstations, and other applications.

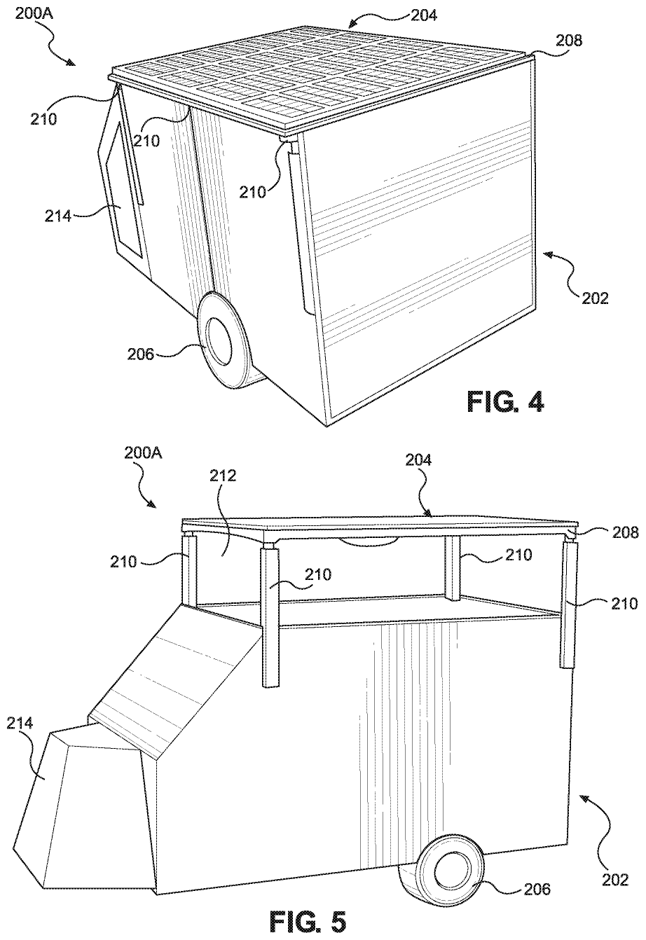

Referring now to FIG. 4 through FIG. 9C, a first application of a MAPS 200 (this first embodiment is shown as MAP 200A) according to an embodiment of the present invention is shown in the context of a mobile vehicle unit (MVU) 202 equipped with a solar panel array 204. This embodiment demonstrates how the perimeter-mounted positioning system can be integrated into a recreational vehicle, trailer, or other vehicles or other size-constrained or transportation-sensitive applications to provide sun-tracking capability for maximum energy collection.

FIG. 4 shows a rear left perspective view of the MVU MVU 202, and includes wheels 206 and a motion platform, in the form of a tiltable roof 208, onto which is mounted the solar panel array 204 that comprises one or more solar panels for capturing sunlight and producing energy. The roof 208 is shown in a fully lowered position suitable for travel, demonstrating the flat-folding capability of the MAPS 200.

In the illustrated embodiment, one or more movement devices 210 preferably allow the roof 208 and the solar array 204 to be moved between several positions and orientations. Preferably, movement devices 210 allow movement about at least two different and orthogonal axes to provide movement in at least two rotational degrees of freedom. As illustrated, four motion devices 210 positioned around the perimeter between the MVU 202 and the roof 208 are used to move the roof 208 between multiple positions and orientations. As a result, the illustrated MVU 202 operates in a pop roof or tilt-roof mode.

The MVU 202 preferably provides a weather-resistant enclosed space 212 that may be used for storage, including storage of batteries, inverters, controllers, racks, monitoring systems, and other components required or useful for solar energy collection and storage systems. Additionally, in preferred embodiments, where the MVU 202 is configured as a recreational vehicle or mobile living unit, the enclosed space 212 may also provide living accommodations including sleeping areas, kitchen facilities, bathroom facilities, and other amenities. In preferred embodiments, MVU 202 is provided with towing means (represented by element 214), which may include a tow hitch, fifth wheel hitch, gooseneck hitch, or other means known to those of skill in the art, for enabling the MVU to be temporarily attached to and then towed by another vehicle.

FIG. 5 shows a front left perspective view of the same MVU 202 with the tiltable roof 208 raised to an extended position. Motion devices 210 positioned around the perimeter between the MVU 202 and the roof 208 have been extended to lift the roof 208 vertically. In this configuration, all motion devices 210 are extended approximately equally, resulting in a horizontal orientation of the roof 208 and solar array 204. In the illustrated embodiment, a movement device 210 is located in each of the four corners of MVU 202, and each is in a fully extended position with the roof 208 oriented in a horizontal position without tilting. Preferably, the vertical lift of the roof 208 is achieved while preserving the interior volume beneath the roof 208, which may be used for living space, storage, or other purposes when the MVU is not in motion.

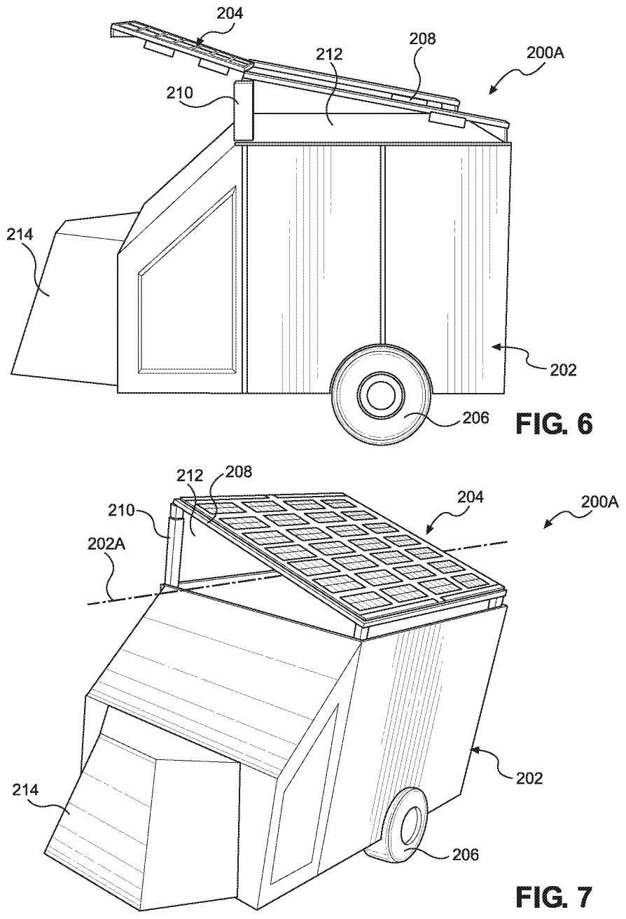

FIG. 6 is a side elevation view of the MVU 202 depicting a first intermediate position, where the tiltable roof 208 is tilted to a rearward tilting position. This orientation is achieved by extending the front motion devices 210 more than the rear motion devices, causing the roof and solar array 204 to tilt about a lateral axis (where the lateral axis is not shown but extends generally into and out of the page). This type of angular positioning is useful for tracking the sun as it moves from east to west during the day.

FIG. 7 shows a front left perspective view of the MVU 202 with the tiltable roof 208 laterally tilted. This orientation is achieved by extending the motion devices 210 on one side more than those on the opposite side, causing the roof and solar array 204 to tilt about a longitudinal axis (represented by axis 202A, which is orthogonal to the previously-described lateral axis). Specifically, in this view, the two right-side movement devices 210 are fully extended and the two left-side movement devices are fully retracted or partially extended to position the roof 208 in a left tilting position. In this example, while the front-to-back tilting described above is useful for tracking the sun as it moves from east to west during the day, this lateral tilting capability allows the system to track the sun's elevation angle, which varies with season and latitude. The actual position and orientation of the rotational axes discussed above along with their use in positioning the roof 2008 and solar array 204 will, of course, depend on the movement of the movement devices 210 and intended position of the solar array and roof.

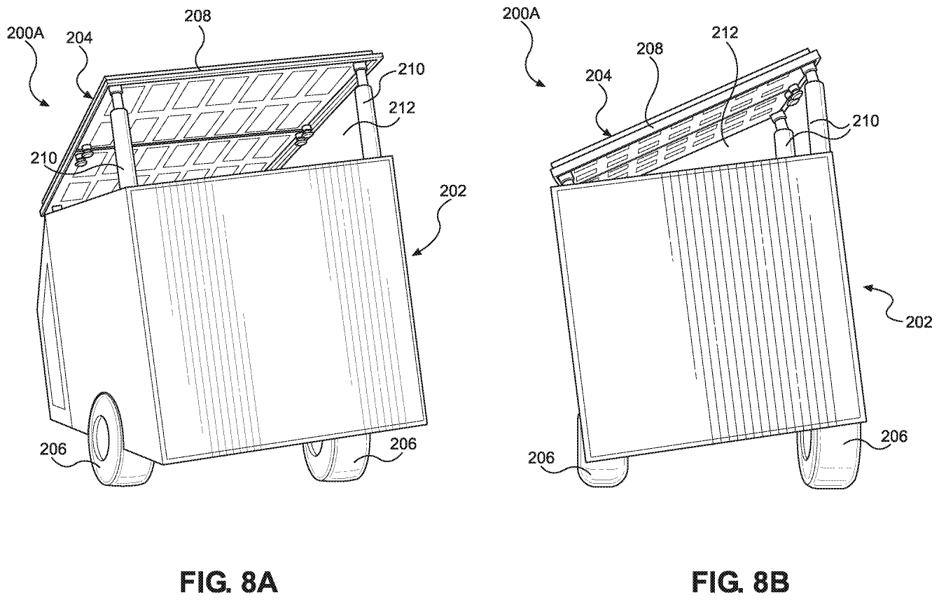

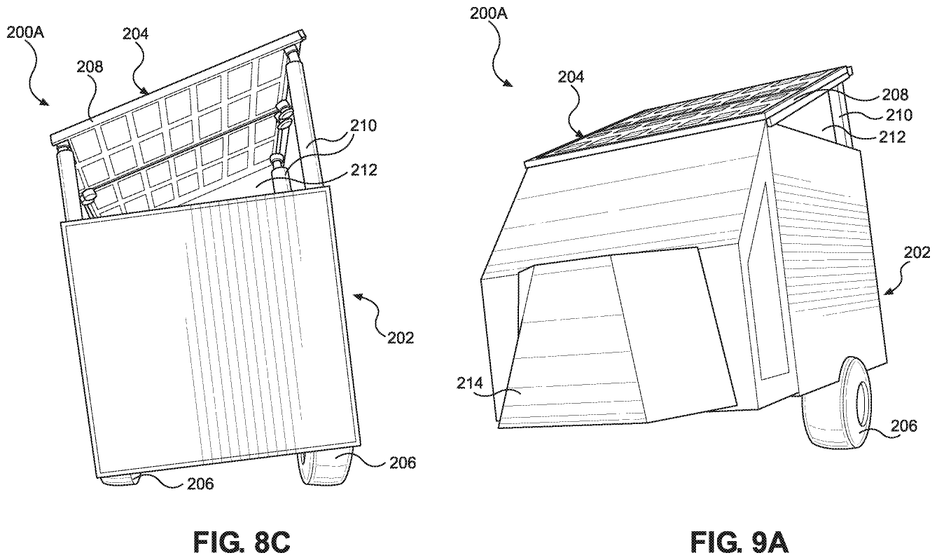

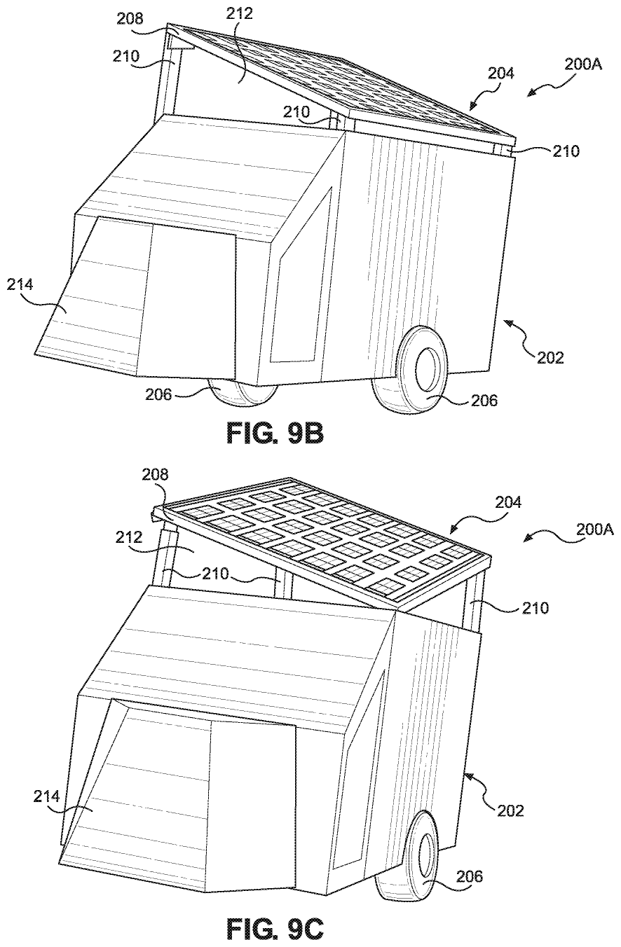

FIGS. 8A-8C and FIGS. 9A-9C are rear perspective views and front perspective views, respectively, showing corresponding additional intermediate positioning capabilities from two different perspectives (i.e., FIG. 8A matches to FIG. 9A, FIG. 8B matches to FIG. 9B, and FIG. 8C matches to FIG. 9C). More particularly, FIGS. 9A, 9B, and 9C provide front left perspective views corresponding to the positions shown in FIGS. 8A, 8B, and 8C, respectively, providing additional visual context for these multi-axis orientations.

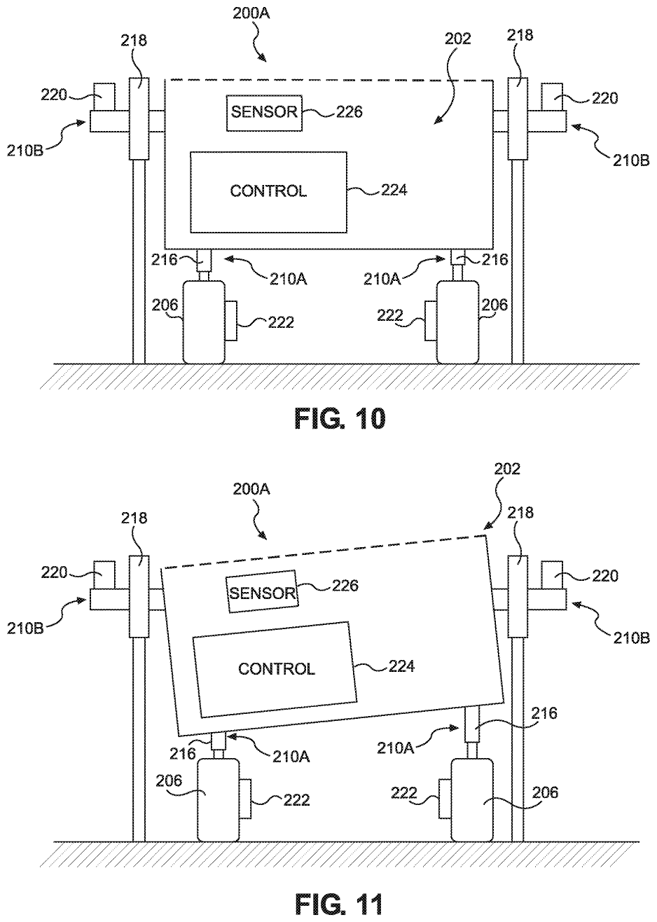

First, FIG. 8A and FIG. 9A show the MVU 202 from FIG. 6, but where the roof 208 and solar array 204 have been tilted to a forward position by fully extending the rear movement devices 210 and fully retracting the forward movement devices. Additionally, in these views, the MVU 202 itself is also tilted with respect to the wheels 206 using a suspension system or jacking system (not shown in these figures but described in greater detail below in connection with FIGS. 10-11) as an additional movement device (i.e., in addition to the movement devices 210 mounted between the roof 208 and the MVU 202). This demonstrates that multiple movement subsystems can be combined to achieve greater angular range than would be possible with a single movement subsystem.

Next, FIG. 8B and FIG. 9B show the MVU 202 from FIG. 7, where the solar array 204 and roof 208 are each angled to the left side (as seen best in FIG. 8B). In this view, both the right-side movement devices 210 are fully extended and both the left-side movement devices are fully retracted. Again, the MVU 202 itself is also tilted with respect to the wheels 206 using a suspension system or jacking system as an additional movement device.

Lastly, in FIG. 8C and FIG. 9C the front-left corner of the solar array 204 and roof 208 are tilted downward by fully extending the rear-right movement device 210, partially extending the front-right and rear-left movement devices, and fully retracting the front-left movement device. This demonstrates the system's ability to achieve complex multi-axis orientations by coordinating the extension and retraction of individual motion devices. Again, the MVU 202 itself is also tilted with respect to the wheels 206 using a suspension system or jacking system as an additional movement device. These views demonstrate the MAPS's 200 ability to achieve complex multi-axis orientations by coordinating the extension and retraction of individual motion devices 210 with the movement of the suspension/jacking system for the MVU 202.

In each of these solar panel application embodiments, a control system (described below) may be programmed to automatically track the sun throughout the day, periodically adjusting the orientation of the roof 208 and solar array 204 to maximize energy collection. In preferred embodiments, the MAPS 200 may incorporate sensors to detect the current position and orientation of the solar array 204, as well as programming to calculate optimal solar tracking angles based on time of day, date, and geographic location.

In the illustrated embodiments, the roof 208 and solar array 204 move together as a motion platform mounted on the linear actuator-type motion devices 210, which may each be driven by a separate drive motor and which cooperate to provide movement of the platform. The movement devices 210 are configured to provide multi-axis positioning capability, allowing the roof 208 and solar array 204 to be oriented through multiple degrees of freedom including vertical translation (heave), rotation about a lateral axis (pitch), and rotation about a longitudinal axis (roll). The movement device 210 may be located partially or fully within the enclosed space 212 of the MVU 202. However, preferably, as much of the area within the enclosed space 212 is preserved and remains free to use for living space, storage, or other purposes.

Referring now to FIG. 10 and FIG. 11, a diagram representative of a hypothetical lower portion of a MAPS 200 (i.e., not including the roof and its associated movement devices) that incorporates various movement devices that may be used, separately or together, in the various embodiments of this disclosure, including the embodiments shown in FIGS. 8A-8C and FIGS. 9A-9C, is shown. These systems can be used separately or in combination with the roof-mounted MAPS 200 to further enhance the range of motion and positioning capability of the solar array 204 or other panel mounted on the MVU 202.

FIG. 10 is a rear elevation view of the MAPS 200 showing movement devices 210 in the form of a suspension system 210A and jacking system 210B with the MVU 202 oriented in a substantially upright position. The suspension system 210A includes adjustable air suspensions 216 mounted to each wheel 206 and the jacking system 210B includes corner jacks 218 positioned at the corners of the MVU 202 that may be used, separately or together, to achieve the desired position and orientation. In the illustrated embodiment, corner jacks 218 are each driven by a separate drive motor 220 and are provided in each of the four corners of the MVU 202 (two of which are visible). In this configuration, the movement devices are positioned to maintain a level, horizontal orientation of the MVU 202.

Air suspension systems are commonly used in recreational vehicles and trailers for ride quality improvement, auto-leveling when parked on uneven surfaces, adjustment for varying payload weights, and increasing ground clearance for off-road use. In the present invention, the air suspension system 210A is also utilized as a movement device for positioning the entire MVU 202 at desired angles to enhance solar tracking or other directional positioning. Each air suspension 216 allows controlled vertical adjustment of the corresponding wheel 206 relative to the MVU 202. By independently controlling the suspension travel at each wheel, the MVU 202 can be tilted laterally, tilted longitudinally, or tilted about both axes simultaneously.

In many cases, the above-described corner jacks 218 are used for leveling purposes similar to those described above in connection with air suspensions 216. However, the corner jacks 218 may also be used to purposefully rotate the MVU 202 to an angled or tilted orientation such that the roof and solar array are placed in a desired orientation. Each corner jack 218 includes a drive motor 220 or other motion device that extends or retracts the jack. By independently controlling the extension of each corner jack 218, the MVU 202 can be lifted, lowered, and tilted in multiple axes. Likewise, wheels 206 provided with drive motors 222 may also be used as a movement device to pivot the entire MVU 202 in sun tracking mode. For example, the tire pressure may be selectively modified (i.e., increased or decreased) to modify the height and orientation of the MVU 202.

FIG. 11 is a rear elevation view of the same MAPS 200 with the movement devices 210 positioned to orient the MVU 202 in a tilted position. By selectively adjusting the extension of individual air suspensions 216 and corner jacks 218, the MVU 202 can be tilted to position a roof-mounted solar array or other object at a desired orientation. This embodiment demonstrates that the principles of perimeter-mounted multi-axis positioning can be applied at different scales and in different contexts beyond dedicated motion platforms. For example, in FIG. 10, all four air suspensions 216 are extended an equal amount such that the roof and solar array would each be raised vertically and oriented horizontally. However, in FIG. 11, the air suspensions 216 on the lefthand side of the MVU 202 are extended less than those on the righthand side of the MVU, which results in a leftward tilt of the MVU and consequently the roof 208 and solar array 204. Of course, the MVU 202 may also be tilted forward/rearwards or at a different orientation that combines lateral tilt with forward/rearwards tilt by selectively adjusting the air suspensions 216 and/or corner jacks 218.

In addition to re-orienting the roof 208 and solar array 204, the air suspensions 210A may also be used for auto-leveling the MVU 202 to improve livability when the MVU is parked on uneven surfaces. In other cases, air suspensions 210A are used while changing payloads or to increase ground clearance and off-road performance. The range of motion depends on the geometry of the air suspensions 210A, and the number and location of the wheels 206 with controlled suspension travel. In certain cases, air suspensions 216 provide a vertical travel distance of 12 inches or more. However, in other embodiments, more or less vertical travel distance is provided by air suspensions 216. In each case, by selecting a desired travel distance on a wheel-by-wheel basis, the orientation of the roof and solar array may be selectively modified.

By combining the tilting capability of the MVU 202 (using air suspensions 216 and/or corner jacks 218) with the tilting capability of the roof 208 relative to the chassis (using movement devices 210), a very wide range of angular positions can be achieved. For example, if the roof-mounted system can tilt the solar array plus or minus twenty degrees and the chassis tilting system can tilt the chassis plus or minus ten degrees, the combined system can achieve plus or minus thirty degrees of tilt. This combined approach leverages existing vehicle systems that are already present for other purposes (leveling, ride quality, stabilization) and integrates them into the overall positioning system. As a result, embodiments of the present invention employing air suspensions 216 and/or corner jacks 218 may be particularly useful for RVs and trailers for leveling purposes. By coordinating the control of these systems, multi-axis positioning capability can be added and used on varying ground surfaces without requiring additional dedicated hardware. The range of angular adjustment will depend on the suspension geometry and the vertical travel distance available from the suspension and jacking components.

Unlike conventional sun-tracking and solar energy collection and storage systems, where sun tracking units are typically bolted to a vehicle, embodiments of the present invention preferably become an integrated part of the vehicle and various existing mechanical elements of the vehicle transform the vehicle itself into a tracking platform. In each implementation of the presently-described systems, a control system 224 controls the various components and provides several modes so that functionality of those mechanical elements is preserved while also permitting and controlling the sun-tracking functionality described above. In preferred embodiments, the control system 224 is in communication with one or more sensors 226 that may be used to serve various functions. For example, sensors 226 may be used for position and orientation tracking of the MVU 202, roof 208, or other components. Similarly, sensors 226 may be used for tracking the position of the sun in order to maximize the effectiveness of the solar array 204. Therefore, one of the modes of operation will be a sun-tracking mode that allows the MVU 202 to maximize solar power generation while parked. Other modes, such as a travel mode (see FIG. 4) or a stationary mode (see FIG. 5) as well as other modes are also available. Next, advantageously, the presently-described systems are lighter in weight and are less complex than conventional sun-tracking and solar energy collection and storage systems. Additionally, the size of the solar array can be much bigger because all the proposed mechanisms are already broadly deployed and strong enough to orient or manipulate an entire vehicle.

### EXAMPLE

In this example, a typical recreational vehicle (RV) is provided with a roof that measures 7.5′ wide x 16′ long. A solar array provided on a pop-up roof is attached to the top of the RV via linear actuators that each provide a 40″ stroke and 450 lbs of lifting force. These actuators, alone and without any other movement device, can provide 23.96 degrees of lateral tilt (in either direction) and 11.77 degrees of fore/aft tilt (in either direction). Additional range or tilt can be provided by using other movement devices. For example, approximately 8-12 degrees of additional lateral tilt (in either direction) may be added by using the vehicle air suspension system, thereby providing more than 30 degrees of lateral tilt (in either direction) with continuous sun tracking during the brightest part of the day. This range of motion is optimal for spring/summer/fall operation at most latitudes. Further, an even greater range of motion (in both axes) can be achieved with high lift corner jacks. Thus, the resulting system will be able to track the sun through the mid-day solar intensity peak, in a wide swath of latitudes and times of the year, without the user having to reposition the vehicle or deploy a stand-alone sun tracking system.

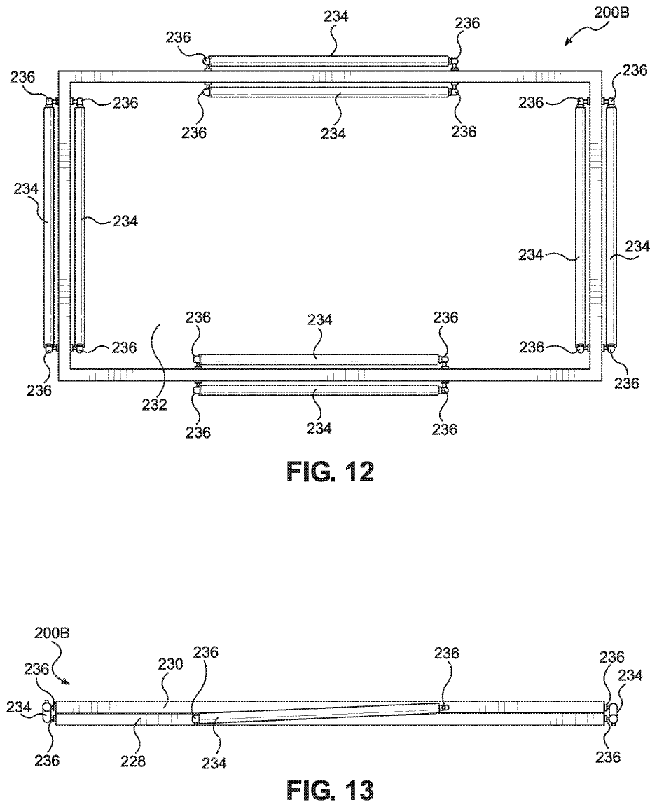

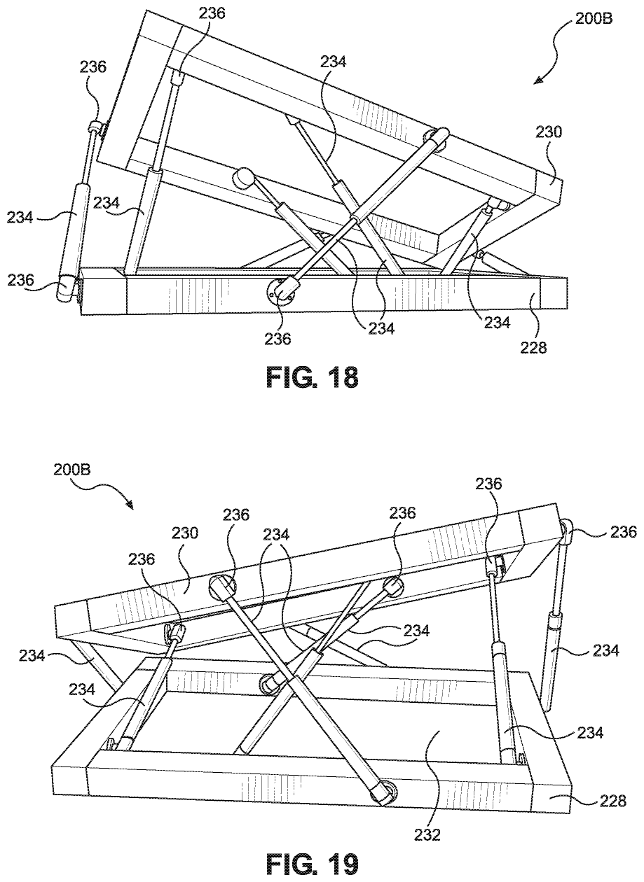

Referring now to FIGS. 12 through 19, a second embodiment of the MAPS 200B is shown. This embodiment illustrates a rectangular perimeter-mounted system with crossing motion devices arranged in an “X” pattern when viewed from the side. This crossing position provides enhanced mechanical advantage and increased vertical lift compared to non-crossing arrangements.

FIG. 12 is a top plan view and FIG. 13 is a side elevation view of the second embodiment showing a rectangular base structure 228 and a corresponding rectangular motion platform 230 that define an internal space 232. Eight linear motion devices 234 in the form of actuators are positioned around the perimeter, with a pair of actuators positioned along each side of the rectangle. On each side, one motion device 234 of the pair is located within the internal space 232 and has its first end connected to the inner surface of the base structure 228 and its second end connected to the inner surface of the motion platform 230. Likewise, the other motion device 234 of the pair is located outside of the internal space 232 and has its first end connected to the outer surface of the base structure 228 and its second end connected to the outer surface of the motion platform 230. Preferably, each end of the motion devices 234 is connected to the base structure 228 and motion platform 230 via universal joints, ball joints, or other articulating connection mechanisms 236 that permit the angular displacement required during operation. When the motion devices 234 extend upward, the actuators forming each pair cross one another to form an “X” pattern when viewed from the side or end of the system. This crossing configuration provides several advantages. First, it allows the use of longer motion devices 234 within a given footprint (e.g., within internal space 232) than would be possible in a non-crossing configuration, which provides greater vertical lift and angular range. Second, the crossing geometry creates favorable angles that enhance the mechanical advantage for vertical lift. Third, the X-pattern provides excellent structural stability and load distribution.

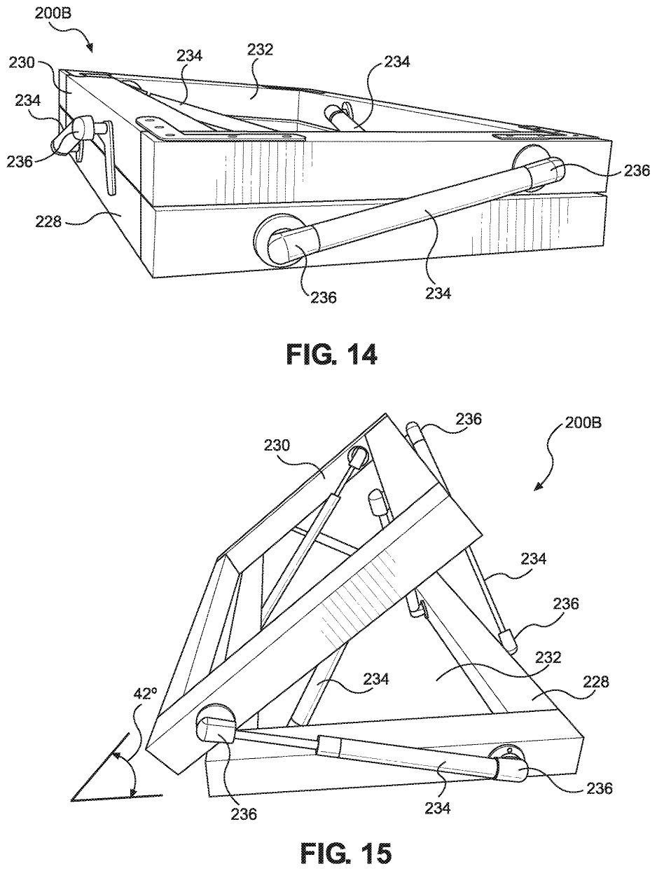

FIG. 14 is a perspective view of the second embodiment showing the MAPS 200B in a collapsed position. In this fully retracted position, the motion platform 230 is positioned immediately adjacent to the base structure 228, demonstrating the flat-folding capability of the system 200B. All motion devices 234 are fully retracted, and the motion platform 230 sits closely adjacent to the base structure 228. The overall height of the collapsed system 200B is substantially equal to the combined thickness of the base structure 228 and the motion platform 230. Advantageously, the internal space 232 remains substantially unobstructed or minimally obstructed by the motion devices 234 and largely available for mounting a solar panel, optical component, or other device.

FIG. 15 is a perspective view of the second embodiment of the MAPS 200B showing the motion platform 230 in a partially raised position with a top surface of the motion platform oriented at an angle of approximately 42 degrees relative to the ground surface upon which the base structure 228 rests. This significant angular displacement is achieved through coordinated extension and retraction of the eight motion devices 234. The crossing motion device 234 arrangement provides the mechanical advantage necessary to achieve this large angular range while maintaining structural stability. In this position, the entire right-hand side of the motion platform 230 is raised while the left-hand side remains lower. This position is achieved by extending the motion devices 234 on the right side while leaving the actuators on the left side retracted or partially extended.

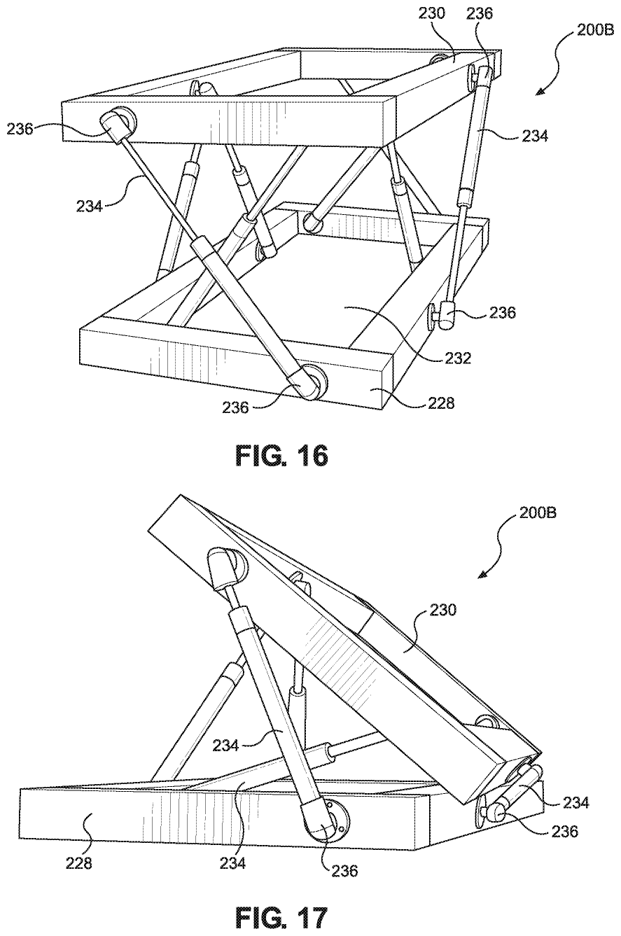

FIG. 16 is a perspective view of the second embodiment of the MAPS 200B showing the motion platform 230 in a fully raised horizontal position. All eight motion devices 234 are extended approximately equally, lifting the motion platform 230 vertically while maintaining a horizontal orientation. The vertical lift achieved in this position substantially exceeds the extension length of the individual motion devices 234 due to the geometric advantage provided by the angled, crossing actuator arrangement. In this position, the mechanical advantage of the system is evident: the vertical lift significantly exceeds the linear extension of the individual motion devices 234 due to the geometry and angles of the connections. In certain implementations, a vertical lift of 150% or more of the actuator extension length can be achieved, with some configurations achieving 175% or greater. The crossing X-pattern of the motion devices 234 is clearly visible in this configuration.

FIGS. 17-19 are perspective views of the second embodiment of the MAPS 200B showing the motion platform 230 from different perspectives when partially raised and tilted on two orthogonal axes simultaneously. This demonstrates the system's ability to achieve complex multi-axis orientations by independently controlling the extension of each motion device 234. Such multi-axis positioning is essential for applications such as solar tracking, optical alignment, and antenna pointing. For example, the motion platform 230 may be tilted about an X-axis (lateral tilt from side to side) and simultaneously about a Y-axis (longitudinal tilt from front to back), where the X-axis and Y-axis are perpendicular to one another and both horizontal to the ground surface.

The above-described second embodiment with crossing motion devices 234 is particularly well-suited for applications requiring maximum vertical lift and angular range within a compact footprint. The crossing arrangement allows longer actuators to be accommodated, and the angled geometry provides enhanced mechanical advantage for both lifting and tilting operations. The eight-actuator rectangular position also provides excellent stability and the ability to resist external forces such as wind loading, as the forces are distributed across eight attachment points rather than the six points typical of conventional Stewart-Gough platforms. The ability to use longer actuators (because they cross rather than interfere with each other) combined with the favorable geometry provides vertical lift ratios that can exceed 175 percent (ex.: 4.2 inches of actuator extension can produce more than 7 inches of vertical lift). Additionally, angular ranges of 80 degrees or more in both tilt axes can be achieved, providing exceptional versatility for solar tracking and other directional positioning applications.

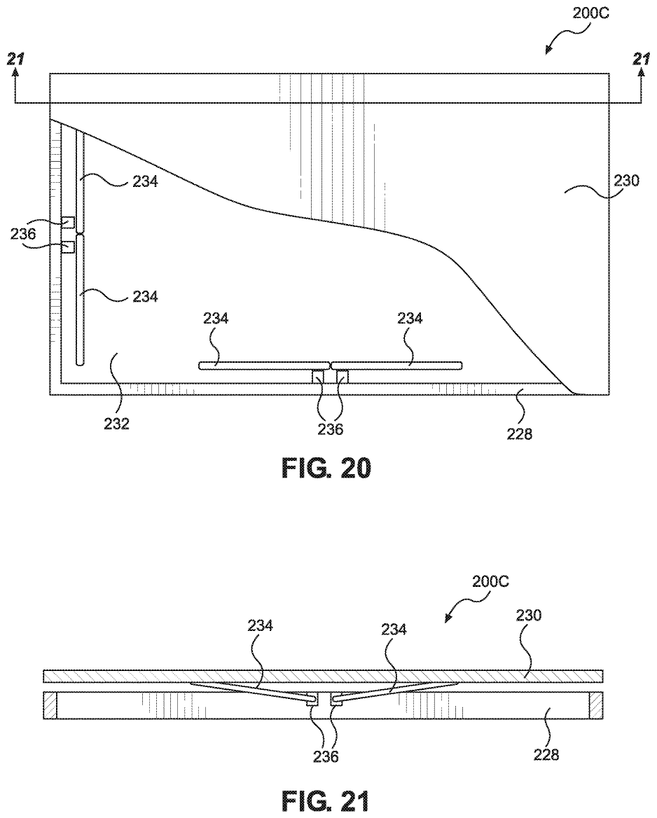

Referring now to FIG. 20 and FIG. 21, a third embodiment of the MAPS 200C is shown. As in the previous embodiment, the third embodiment includes a rectangular base structure 228 and a corresponding rectangular motion platform 230 that define an internal space 232. Additionally, motion devices 234 are mounted between and connect together the base structure 228 and the motion platform 230, with their first ends connected to the base structure and their second ends connected to the bottom surface of the motion platform. However, unlike the prior embodiment, non-crossing motion devices 234 are used. In this case, each pair of motion devices 234 located on each side of the base structure 228 is arranged in a butt-to-butt or parallel configuration such that they do not cross one another when extended. In the non-crossing configuration, both actuators of each pair are mounted to the same surface—either both on the inner surface of the base structure 228 and motion platform 230 (as shown in FIGS. 20-22) or both on the outer surface—and are positioned adjacent to one another. This arrangement, where both actuators are on the same surface rather than opposing surfaces, prevents the actuators from crossing during extension. While this arrangement provides somewhat less angular range than the crossing actuator configuration, it offers certain advantages including improved weatherproofing, the use of lighter and lower cost actuators (i.e., because they are shorter) and reduced potential for actuator interference.

This configuration may be preferred in applications where weatherproofing is important. Because the actuators do not cross, and because all actuators can be mounted inside the perimeter of the base, they can more easily be enclosed within protective bellows, boots, or housings that shield them from rain, snow, dust, and other environmental factors. The non-crossing arrangement also eliminates any possibility of interference between actuators during operation and simplifies sealing between the base structure and the motion platform.

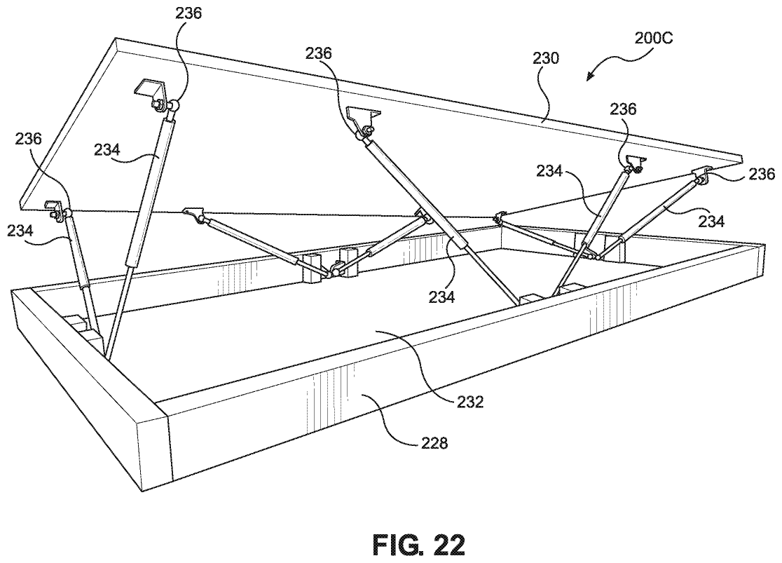

Finally, in FIG. 22, the third embodiment of the MAPS 200C is shown with the motion platform 230 in a partially raised two-axis tilt position. Despite the non-crossing actuator arrangement, the system 200C is still capable of achieving multi-axis positioning with substantial angular range in both pitch and roll axes. The motion platform 230 is elevated above the base structure 228 and tilted about both the X-axis and Y-axis. This demonstrates that the non-crossing configuration is fully capable of providing multi-axis positioning with multiple degrees of freedom, including vertical translation, lateral tilt (roll), and longitudinal tilt (pitch). The range of motion may be somewhat less than that achievable with the crossing actuator configuration, but remains sufficient for many applications including solar tracking, antenna pointing, and optical alignment.

The choice between the crossing actuator position of the second embodiment and the non-crossing position of the third embodiment will depend on the specific requirements of the application. For applications requiring maximum angular range and vertical lift, the crossing position may be preferred. For applications where weatherproofing, simplicity, or actuator protection are paramount, the non-crossing position may be more suitable. While the non-crossing configuration may provide somewhat less vertical lift and angular range than the crossing configuration (due to shorter effective actuator lengths and different geometric relationships), it offers compensating advantages in terms of weather sealing, mechanical simplicity, and ease of integration into enclosures.

Both the crossing (second embodiment) and non-crossing (third embodiment) configurations share the fundamental advantages of perimeter-mounted architecture: flat folding capability, preservation of interior volume, modular integration, and the ability to be scaled to various sizes and shapes depending on application requirements.

All of the embodiments described above may incorporate a control system for coordinating the operation of the multiple motion devices. The control system 224 (FIG. 11) typically includes a controller or processor, memory, control software, power supplies or power distribution systems for the motion devices, and user interface components allowing an operator to command desired positions and orientations. In preferred embodiments, the control system 224 employs inverse kinematics calculations to determine the required extension length for each motion device to achieve a desired position and orientation of the motion platform. Inverse kinematics is a computational technique commonly used in robotics and motion control to determine the joint positions (in this case, actuator extensions) required to achieve a desired end-effector position (in this case, the motion platform position and orientation). Given a target position and orientation for the motion platform, the inverse kinematics algorithm calculates the length that each actuator must have to place the motion platform in that position and orientation. Inverse kinematics are not the only possible method of controlling the motion platform and associated vehicle control systems, but they are likely the most computationally efficient. Other possible methods include feedback-based systems (e.g., measuring force, current, etc. to individual actuators), direct kinematics, machine learning, etc. It is also possible to use multiple methods of system monitoring and control—i.e. inverse kinematics and current monitoring at each actuator to detect faults.

For a MAPS according to the present invention, the inverse kinematics problem may be solved as follows. First, the desired position and orientation of the motion platform is specified, typically in terms of the X, Y, and Z coordinates of the platform center and the angular orientation about two or three axes (pitch, roll, and optionally yaw). Next, the position of each connection point on the motion platform is calculated based on the desired platform position and orientation. Although solar tracking applications typically utilize only three degrees of freedom (vertical translation, pitch rotation, and roll rotation), the system architecture inherently supports full six-degree-of-freedom positioning including yaw rotation and X-Y translation, which may be valuable for other applications such as optics, antennas, or industrial positioning. Then, for each motion device, the required length is calculated based on the distance between the fixed connection point on the base structure and the calculated position of the corresponding connection point on the motion platform. Finally, control signals are sent to each motion device to command the calculated extension lengths.

The inverse kinematics calculation considers the geometry of the system including the dimensions and shape of the base structure and motion platform, the locations of the connection points where the actuators attach to the base and platform, and the articulation characteristics of the connection joints. For a rectangular perimeter-mounted system with eight actuators as described in the second and third embodiments, the inverse kinematics involves solving for eight actuator lengths given a desired motion platform position defined by vertical height (Z), lateral tilt angle (roll about X-axis), and longitudinal tilt angle (pitch about Y-axis).

In some cases, the system is over-constrained or redundant, meaning there are more actuators than strictly necessary for the degrees of freedom being controlled. In such cases, the inverse kinematics solution may employ optimization techniques to distribute the load among actuators, minimize actuator extensions, or optimize for other criteria such as energy efficiency or mechanical advantage. Furthermore, in cases where the system is over-constrained and under-loaded, some of the active actuators may be replaced by passive gas struts or similar passive springs. Unlike the actuators used in this application, gas struts or springs can be back driven, meaning that they can be compressed by sufficient external force/loading to the platform. Therefore, they can help distribute loads, increase stability, and lower stress on the active actuators, but in the event of extraordinary loads, they will not provide the same strength a non-backdrivable actuator.

The inverse kinematics calculations may be performed in real-time as the operator adjusts the desired position, or may be performed in advance to generate a series of positions for automated motion sequences such as solar tracking. Modern microcontrollers and embedded processors are capable of performing these calculations with sufficient speed for real-time control.

The control system may also incorporate feedback sensors to detect the actual position and orientation of the motion platform. Such sensors may include linear position sensors on each actuator (such as Hall-Effect sensors, potentiometers, linear encoders, or magnetostrictive position sensors), accelerometers or inclinometers mounted on the motion platform to detect angular orientation, or other suitable sensing devices. Feedback from these sensors allows the control system to implement closed-loop control, adjusting actuator extensions as necessary to achieve and maintain the desired position despite external disturbances such as wind loading.

For solar tracking applications, the control system may be programmed with algorithms to automatically track the sun's position throughout the day and throughout the year. Such algorithms may calculate the sun's position based on time of day, date, and geographic location (latitude and longitude), and may periodically adjust the orientation of the motion platform to maintain optimal alignment with the sun. The control system includes or communicates with a sun position calculator that determines the current position of the sun based on date, time, and geographic coordinates. Sun position algorithms such as the Solar Position Algorithm (SPA) published by the National Renewable Energy Laboratory can calculate the sun's azimuth angle and elevation angle with high accuracy. The control system then uses inverse kinematics to determine the motion platform orientation that will face the solar panel directly toward the calculated sun position, and commands the actuators accordingly.

In some embodiments, light sensors or sun sensors may be incorporated to provide direct feedback regarding the alignment between the solar panels and the sun, allowing the control system to make fine adjustments to optimize energy collection. The control system preferably implements periodic sun tracking, where the sun position is recalculated and the panel orientation adjusted at regular intervals, such as every one minute, every five minutes, every fifteen minutes, or other suitable interval. The update interval represents a trade-off between tracking accuracy and actuator wear; more frequent updates provide better alignment but cause more actuator movement.

The control system may also incorporate safety features and operational modes beyond sun tracking. For example, a “stow” mode may automatically retract all actuators to position the motion platform in the flat-folded position suitable for transportation. A “level” mode may be used to selective position the MVU, base structure, or the motion platform in a horizontal orientation regardless of the angle of the other components, which may be useful for applications such as leveling a recreational vehicle on uneven terrain. A “manual” mode may allow the operator to directly control individual actuators or groups of actuators for setup, maintenance, or specialized positioning tasks.

In some embodiments, the control system includes manual override controls allowing a user to manually specify a desired panel orientation, bypass automatic tracking, or command the system to return to a home position (such as fully collapsed for travel or fully raised and horizontal for stationary use).

For MVU applications incorporating multiple movement subsystems (roof actuators, suspension system, jacking system, wheel drive), the control system preferably coordinates all subsystems to achieve the desired overall positioning. The system may employ a hierarchical control strategy where coarse positioning is achieved using wheel drive to rotate the vehicle and/or suspension/jacking to tilt the chassis, while fine positioning is achieved using the roof-mounted actuators.

Preferably, the control system is agnostic to the type of motion device employed. Whether the actuators are electric, hydraulic, or pneumatic, the same inverse kinematics mathematics applies to calculate required lengths. However, the specific control signals and feedback mechanisms may differ depending on actuator type. Electric linear actuators typically use encoder feedback and motor current control. Hydraulic actuators use valve control and pressure/position sensors. Pneumatic actuators use pressure regulators and position sensors. The control system is configured with appropriate drivers and interfaces for the specific actuator type employed. It is also possible to use a tension based system, with passive springs or gas struts applying continuous lifting force on the platform, and cables pulling down on motion platform. This is applicable when the motion platform experiences lower forces, and lower cost and control system simplicity is preferred.

While the detailed description above focuses on solar panel positioning and vehicle-based applications, the MAPS of the present invention have broad applicability across many fields and industries.

In the field of optics, the positioning systems may be used to aim telescopes, cameras, or other optical instruments toward celestial objects or terrestrial targets. The flat-folding capability and preservation of interior volume make these systems particularly suitable for satellite-based optics, where compact stowage during launch and a clear optical path during operation are essential. The positioning system may support a primary mirror, secondary mirror, or entire telescope assembly, providing the multi-axis pointing capability required for astronomical observation or Earth imaging. Unlike solar tracking applications which require only vertical lift, pitch, and roll, optical applications may benefit from the full six degrees of freedom provided by the MAPS architecture, including yaw rotation and lateral X-Y translation for precise target acquisition, tracking, and focal length control.

In communications applications, the positioning systems may be used to aim directional antennas such as parabolic dish antennas, phased array antennas, or microwave relay antennas. Mobile communication systems, satellite ground stations, and temporary communication installations can benefit from the ability to rapidly deploy from a compact folded position and then precisely aim the antenna for optimal signal strength.

In industrial and manufacturing settings, the positioning systems may be used as adjustable work platforms, positioning stages for assembly operations, or adaptable support structures for manufacturing equipment. The large load capacity provided by the eight-actuator rectangular position makes these systems suitable for heavy industrial applications. The ability to precisely control position and orientation in multiple axes is valuable for assembly operations, machining operations, and material handling.

In entertainment and display applications, the positioning systems may be used to aim lights, lasers, projection screens, signs, or other visual elements. Theatrical lighting, outdoor advertising displays, and architectural lighting installations can benefit from automated multi-axis positioning capability. The flat-folding capability is particularly valuable for touring shows and temporary installations that must be transported between venues.

In agricultural applications, the positioning systems may be used to aim solar panels for farm power generation, to position shade structures or protective covers over crops, or to aim irrigation equipment or sensors. The rugged construction and weather-resistant design suitable for outdoor solar installations are equally applicable to agricultural environments.

For furniture applications, the MAPS may form an adjustable table, desk, or work surface that can be raised, lowered, and tilted as needed. The flat-folding capability allows the table to collapse to a very low profile for storage or transportation.

For vehicle applications beyond RVs and trailers, the system may be integrated into boats, aircraft, drones, or other vehicles where multi-axis positioning of solar panels, antennas, sensors, or other equipment is required. The modular nature of the perimeter-mounted design facilitates integration into diverse vehicle platforms.

The shape of the base structure and motion platform need not be limited to rectangles or squares. Hexagonal, octagonal, or other polygonal shapes may be used, with motion devices positioned around the perimeter in accordance with the same principles described above. For certain applications, circular or oval platforms may be preferred, with motion devices positioned around the circumference at regular or irregular intervals. For polygonal configurations, at least two motion devices are preferably positioned along each side or edge of the perimeter. For circular or oval configurations, the motion devices are distributed around the circumference of the perimeter at regular or irregular intervals.

The number of motion devices may also be varied. While the embodiments described above employ eight actuators (two per side on a rectangular platform), fewer or more actuators may be used. For a rectangular platform, a minimum of four actuators (one per corner) can provide multi-axis positioning, though with reduced stability and load capacity compared to eight-actuator positions. Additional actuators beyond eight may be added to increase load capacity, improve stability, or provide redundancy. For example, three actuators per side (twelve total) could be used for very large platforms or very heavy loads.

The motion devices themselves may take many forms. Electric linear actuators with screw drives or belt drives are suitable for many applications and offer precise control and position feedback. Hydraulic cylinders provide high force capacity and are well-suited for heavy-duty applications or situations where hydraulic power is already available. Pneumatic cylinders offer rapid actuation and are suitable for applications requiring frequent position changes. Telescoping struts, motorized screw drives, and other linear motion mechanisms may also be employed.

The connection mechanisms between the motion devices and the base structure and motion platform may be implemented using universal joints (U-joints), ball joints, spherical bearings, rod ends, or other articulating connections that permit the angular displacement required during multi-axis motion. The choice of connection mechanism will depend on the loads involved, the range of angular displacement required, and environmental considerations such as weather exposure.

In some embodiments, passive resilient elements such as gas springs, coil springs, or elastomeric supports may be incorporated in addition to or in place of some of the powered motion devices. For example, gas springs could provide an upward biasing force to assist in lifting the motion platform, while a smaller number of powered actuators provide controlled positioning. In such positions, the control system would account for the forces provided by the passive resilient elements when calculating the required actuator forces. In some embodiments, particularly those employing more than the minimum number of actuators required for the degrees of freedom being controlled, some actuators may be passive rather than active. For example, a passive gas spring or mechanical spring may be used to provide upward bias force, with active actuators (either powered linear actuators or tension cables) used for controlled positioning. Such hybrid active/passive configurations may be advantageous in applications where weight savings or simplified control is desired.

### ADVANTAGES AND BENEFITS

The MAPS described herein provide numerous advantages over conventional motion platforms and positioning systems. The perimeter-mounted motion device arrangement allows the system to fold flat into an extremely low-profile position, with the collapsed height equal to or only slightly greater than the combined thickness of the base structure and motion platform. This flat-folding capability is essential for transportation, for integration into space-constrained environments, and for any application where compact stowage is required.

The preservation of interior volume between the base structure and motion platform is another significant advantage. By positioning the motion devices around the perimeter rather than within the interior space, the volume between the platforms remains unobstructed and available for other uses. For optical applications, this provides a clear path for light to pass through the system. For vehicle applications, this preserves usable space for occupants or cargo. For industrial applications, this allows access to the underside of the motion platform for mounting equipment or routing utilities.

The mechanical advantage provided by the perimeter-mounted geometry, particularly in the crossing actuator position, allows substantial vertical lift and angular range to be achieved with relatively compact actuators. Vertical lift exceeding 176% of actuator extension length has been demonstrated, and angular ranges exceeding ±40 degrees in multiple axes are achievable. This combination of compact actuators and large range of motion is difficult or impossible to achieve with conventional interior-mounted actuator platforms.

The structural stability provided by the eight-actuator rectangular position is superior to that of conventional six-actuator platforms. The eight attachment points distribute loads more evenly and provide better resistance to overturning moments caused by wind or other external forces. This enhanced stability is particularly important for mobile applications and outdoor installations where wind loading can be significant.

The modular, thin-layer design of the positioning systems facilitates integration into existing structures. Rather than requiring dedicated mounting systems or significant structural modifications, the positioning system can be incorporated as a layer added to the perimeter of an existing object or structure. This ease of integration reduces installation costs and time, and makes the technology accessible for retrofit applications where existing equipment or structures are being upgraded with positioning capability. Because the motion devices connect to the perimeters of the base structure and motion platform, the system can be added without requiring modifications to the interior of the base structure.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A flat-folding multi-axis positioning system comprising:
a base structure defining a perimeter;
a motion platform defining a perimeter corresponding to the perimeter of the base structure; and
a plurality of motion devices arranged around the perimeters of the base structure and the motion platform, each motion device having a first end coupled to the base structure and a second end coupled to the motion platform, wherein the plurality of motion devices are configured to cooperatively position the motion platform relative to the base structure with at least two degrees of freedom including vertical translation and angular rotation about at least one axis,
wherein the plurality of motion devices are arranged such that when the motion platform is in a fully retracted position, a height of the system is substantially equal to a sum of thicknesses of the base structure and the motion platform,
wherein the plurality of motion devices are arranged such that the motion platform can be moved to a retracted position in which a height of the system is minimized, and
wherein the plurality of motion devices are positioned around the perimeters such that an interior region between the base structure and the motion platform remains substantially unobstructed throughout a range of motion of the motion platform.

2. The system of claim 1, wherein the perimeter of the base structure and the perimeter of the motion platform are each selected from the group consisting of: rectangular, square, polygonal with more than four sides, circular, and oval.

3. The system of claim 1, wherein the perimeter of the base structure and the perimeter of the motion platform are each rectangular, and wherein the plurality of motion devices comprises at least eight actuators arranged with at least two actuators on each side of the rectangular perimeters.

4. The system of claim 3, wherein on each side of the rectangular perimeters, two actuators are angled to oppose one another.

5. The system of claim 4, wherein the two actuators on each side cross one another to form an X-pattern when viewed from a direction perpendicular to that side.

6. The system of claim 4, wherein the two actuators on each side do not cross one another.

7. The system of claim 1, wherein the system is configured to provide vertical translation of the motion platform exceeding 100% of an extension length of the plurality of motion devices.

8. The system of claim 1, wherein the system is configured to provide vertical translation of the motion platform exceeding 140% of an extension length of the plurality of motion devices.

9. The system of claim 1, wherein the coupling of each of the plurality of motion devices to the base structure and to the motion platform comprises a universal joint, ball joint, or spherical bearing.

10. The system of claim 1, wherein the plurality of motion devices are selected from the group consisting of: electric linear actuators, hydraulic cylinders, pneumatic cylinders, gas springs, and mechanical springs.

11. The system of claim 1, further comprising a control system configured to:
determine a desired orientation of the motion platform;
calculate required lengths for each of the plurality of motion devices to achieve the desired orientation using inverse kinematics; and
command the plurality of motion devices to extend or retract to the calculated required lengths.

12. The system of claim 11, wherein the control system is configured to determine the desired orientation based on a position of the sun to orient a solar panel mounted on the motion platform toward the sun.

13. The system of claim 1, further comprising a solar panel mounted on an upper surface of the motion platform.

14. A method of positioning a panel relative to a base surface, the method comprising:
providing a flat-folding multi-axis positioning system comprising a base structure defining a perimeter, a motion platform defining a corresponding perimeter, and a plurality of motion devices arranged around the perimeters and connecting the base structure to the motion platform, wherein the plurality of motion devices are arranged such that when the motion platform is in a fully retracted position, a height of the system is substantially equal to a sum of thicknesses of the base structure and the motion platform;
determining a desired orientation for the panel;
calculating required lengths for each of the plurality of motion devices to achieve the desired orientation using inverse kinematics; and
commanding the plurality of motion devices to extend or retract to the calculated required lengths to position the panel in the desired orientation.

15. The method of claim 14, wherein determining the desired orientation comprises calculating a position of the sun and orienting the panel to face toward the sun.

16. The method of claim 15, further comprising periodically recalculating the position of the sun and adjusting the orientation of the panel to track movement of the sun.

17. The method of claim 14, wherein the panel comprises a solar panel, and wherein the method further comprises generating electrical energy from the solar panel while maintaining the solar panel oriented toward the sun.

18. A flat-folding multi-axis positioning system comprising:
a base structure;
a motion platform;
a plurality of motion devices connecting the base structure to the motion platform, wherein the plurality of motion devices comprises at least two motion devices positioned on each side of a perimeter defined by the base structure and the motion platform, and wherein adjacent motion devices on each side are angled to oppose one another; and
a control system configured to independently control extension and retraction of each of the plurality of motion devices to position the motion platform with at least two degrees of freedom,
wherein the plurality of motion devices are arranged such that when the motion platform is in a fully retracted position, a height of the system is substantially equal to a sum of thicknesses of the base structure and the motion platform,
wherein the system is configured such that when the motion platform is in a fully retracted position, a height of the system is substantially equal to a sum of thicknesses of the base structure and the motion platform.

19. The system of claim 18, wherein the control system is configured to:
receive input indicating a target orientation for the motion platform;
solve inverse kinematics to determine required lengths for each of the plurality of motion devices; and
command each actuator to the required length to achieve the target orientation.

20. The system of claim 18, wherein the perimeter is selected from the group consisting of:
rectangular, square, hexagonal, octagonal, circular, and oval, and wherein a number of the plurality of actuators is at least four.
